(19) United States
(12) Patent Application Publication
(10) Pub. No.: US 2026/0188579 A1
(43) Pub. Date: Jul. 2, 2026

(54) MULTILAYER CERAMIC CAPACITOR AND METHOD OF MANUFACTURING MULTILAYER CERAMIC CAPACITOR

(71) Applicant: Murata Manufacturing Co., Ltd., Nagaokakyo-shi (JP)

(72) Inventors: Ryutaro YAMATO, Nagaokakyo-shi (JP); Yukihiro FUJITA, Nagaokakyo-shi (JP); Yusuke MAKI, Nagaokakyo-shi (JP); Chihiro OKUTANI, Nagaokakyo-shi (JP)

(21) Appl. No.: 19/551,841

(22) Filed: Feb. 27, 2026

Related U.S. Application Data
(63) Continuation of application No. PCT/JP2024/030417, filed on Aug. 27, 2024.

(30) Foreign Application Priority Data
Sep. 22, 2023 (JP) 2023-158121

(51) Int. Cl. H01G 4/012; H01G 4/30

(52) U.S. Cl. CPC H01G 4/012; H01G 4/30

(57) ABSTRACT

A multilayer ceramic capacitor includes first and second inner electrode layers alternately laminated in a lamination direction with dielectric layers therebetween. Via conductors are electrically connected to the first inner electrode layers. The via conductors extend from an inside of a capacitor body to a first main surface of the capacitor body on one side in the lamination direction. Base electrode layers are provided on a portion of the via conductors on the first main surface. Plating layers are provided on the base electrode layers such that surfaces of the via conductors on which the base electrode layers are not provided are exposed to the outside on the first main surface.

### CROSS REFERENCE TO RELATED APPLICATIONS

This application claims the benefit of priority to Japanese Patent Application No. 2023-158121 filed on Sep. 22, 2023 and is a Continuation Application of PCT Application No. PCT/JP 2024/030417 filed on Aug. 27, 2024. The entire contents of each application are hereby incorporated herein by reference.

### BACKGROUND OF THE INVENTION

### 1. Field of the Invention

The present invention relates to multilayer ceramic capacitors and methods of manufacturing multilayer ceramic capacitors.

### 2. Description of the Related Art

Japanese Unexamined Patent Application Publication No. 2016-066783 discloses a multilayer ceramic capacitor including a multilayer body in which dielectric layers and inner electrode layers including a base metal as a main component are alternately laminated, and an outer electrode including an outer electrode body formed on the surface of the multilayer body and a plating layer formed on the surface of the outer electrode body. The outer electrode body is formed such that a portion thereof wraps around from the end surface of the multilayer body to the side surface. In addition, Japanese Unexamined Patent Application Publication No. 2016-066783 describes that the absolute amount of hydrogen included in a multilayer ceramic capacitor is preferably reduced to avoid adverse effects, such as the degradation of the insulation resistance, caused by hydrogen generated during a plating process or the like and included therein.

As the performance of a semiconductor package advances, there is a demand for a decoupling capacitor that can be disposed near a semiconductor package. As such a capacitor, there is a need for a multilayer ceramic capacitor that further includes a via conductor extending in the lamination direction of a multilayer body, which differs from the multilayer ceramic capacitor disclosed in Japanese Unexamined Patent Application Publication No. 2016-066783. Also in a multilayer ceramic capacitor including a via conductor, a reduction in the insulation resistance of the multilayer ceramic capacitor, which is caused by hydrogen generated during forming of the plating layer and included in dielectric layers, is preferably reduced or prevented.

### SUMMARY OF THE INVENTION

Example embodiments of the present provide multilayer ceramic capacitors each including a via conductor in which a decrease in insulation resistance due to hydrogen in dielectric layers is reduced or prevented.

A multilayer ceramic capacitor according to an example embodiment of the present invention includes a capacitor body and an outer electrode. The capacitor body includes a plurality of dielectric layers, a plurality of first inner electrode layers, a plurality of second inner electrode layers, and a via conductor. The plurality of first inner electrode layers and the plurality of second inner electrode layers are alternately laminated in a lamination direction with the plurality of dielectric layers therebetween. The via conductor is electrically connected to the plurality of first inner electrode layers. The via conductor extends from an inside of the capacitor body to a first main surface of the capacitor body on one side in the lamination direction. The outer electrode includes a base electrode layer and a plating layer. The base electrode layer is provided on a portion of the via conductor on the first main surface. The plating layer is provided on the base electrode layer such that a surface of the via conductor on which the base electrode layer is not provided is exposed to an outside on the first main surface.

A multilayer ceramic capacitor according to another example embodiment of the present invention includes a capacitor body and an outer electrode. The capacitor body includes a plurality of dielectric layers, a plurality of first inner electrode layers, a plurality of second inner electrode layers, and a via conductor. The plurality of first inner electrode layers and the plurality of second inner electrode layers are alternately laminated in a lamination direction with the plurality of dielectric layers therebetween. The via conductor is electrically connected to the plurality of first inner electrode layers. The via conductor extends from an inside of the capacitor body to a first main surface of the capacitor body on one side in the lamination direction. The outer electrode includes a base electrode layer and a plating layer. The base electrode layer is provided such that the via conductor is not exposed to an outside on the first main surface. The plating layer is provided on the base electrode layer such that at least a portion of the base electrode layer that is aligned with the via conductor in the lamination direction is exposed to the outside in the lamination direction.

According to another example embodiment of the present invention, a method of manufacturing a multilayer ceramic capacitor includes preparing a capacitor body that includes a plurality of dielectric layers, a plurality of first inner electrode layers, a plurality of second inner electrode layers, and a via conductor, in which the plurality of first inner electrode layers and the plurality of second inner electrode layers are alternately laminated in a lamination direction with the plurality of dielectric layers therebetween, and the via conductor is electrically connected to the plurality of first inner electrode layers and extends from an inside of the capacitor body to a first main surface of the capacitor body on one side in the lamination direction, providing a base electrode layer on a portion of the via conductor on the first main surface, forming a plating layer on the base electrode layer such that a surface of the via conductor on which the base electrode layer is not provided is exposed to an outside on the first main surface, and heating the capacitor body to diffuse hydrogen included in the plurality of dielectric layers in the via conductor and discharge the hydrogen to the outside through the first main surface, after forming the plating layer.

According to another example embodiment of the present invention, a method of manufacturing a multilayer ceramic capacitor includes preparing a capacitor body that includes a plurality of dielectric layers, a plurality of first inner electrode layers, a plurality of second inner electrode layers, and a via conductor, in which the plurality of first inner electrode layers and the plurality of second inner electrode layers are alternately laminated in a lamination direction with the plurality of dielectric layers therebetween, and the via conductor is electrically connected to the plurality of first inner electrode layers and extends from an inside of the capacitor body to a first main surface that is a surface of the capacitor body on one side in the lamination direction, providing a base electrode layer such that the via conductor is not exposed to an outside on the first main surface, forming a plating layer on the base electrode layer such that at least a portion of the base electrode layer that is aligned with the via conductor in the lamination direction is exposed to the outside in the lamination direction, and heating the capacitor body to diffuse hydrogen included in the plurality of dielectric layers in the via conductor and the base electrode layer in the lamination direction and discharge the hydrogen to the outside, after forming the plating layer.

According to example embodiments of the present invention, in multilayer ceramic capacitors each including a via conductor, a decrease in insulation resistance due to hydrogen in the dielectric layers is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view illustrating a multilayer ceramic according to an example embodiment 1 of the present invention.

FIG. 2 is a plan view illustrating the multilayer ceramic capacitor according to example embodiment 1 of the present invention as viewed from another side.

FIG. 3 is a cross-sectional view of the multilayer ceramic capacitor in FIG. 1 as viewed in the direction of arrows III-III.

FIG. 4 is a cross-sectional view of the multilayer ceramic capacitor in FIG. 3 as viewed in the direction of arrows IV-IV.

FIG. 5 is a cross-sectional view of the multilayer ceramic capacitor in FIG. 3 as viewed in the direction of arrows V-V.

FIG. 6 is a flowchart illustrating an example of a method of manufacturing the multilayer ceramic capacitor according to example embodiment 1 of the present invention.

FIG. 7 is a cross-sectional view schematically illustrating the process of forming a plating layer in example embodiment 1 of the present invention.

FIG. 8 is a plan view of a multilayer ceramic capacitor according to example embodiment 2 of the present invention as viewed from a second main surface side.

FIG. 9 is a cross-sectional view of the multilayer ceramic capacitor in FIG. 8 as viewed in the direction of arrows IX-IX.

FIG. 10 is a plan view of a multilayer ceramic capacitor according to example embodiment 3 of the present invention as viewed from the second main surface side.

FIG. 11 is a cross-sectional view of the multilayer ceramic capacitor in FIG. 10 as viewed in the direction of arrows XI-XI.

FIG. 12 is a plan view of a multilayer ceramic capacitor according to example embodiment 4 of the present invention as viewed from a first main surface side.

FIG. 13 is a cross-sectional view of the multilayer ceramic capacitor in FIG. 12 as viewed in the direction of arrows XIII-XIII.

FIG. 14 is a flowchart illustrating an example of a method of manufacturing the multilayer ceramic capacitor according to example embodiment 4 of the present invention.

FIG. 15 is a cross-sectional view schematically illustrating a process of forming a plating layer in example embodiment 4 of the present invention.

### DETAILED DESCRIPTION OF THE EXAMPLE EMBODIMENTS

Multilayer ceramic capacitors, methods of manufacturing multilayer ceramic capacitors, and methods of manufacturing mounting structures of multilayer ceramic capacitors according to example embodiments of the present invention will be described below with reference to the drawings. In the description of the example embodiments described below, the same or corresponding portions in the drawings are denoted by the same reference numerals, and the description will not be repeated.

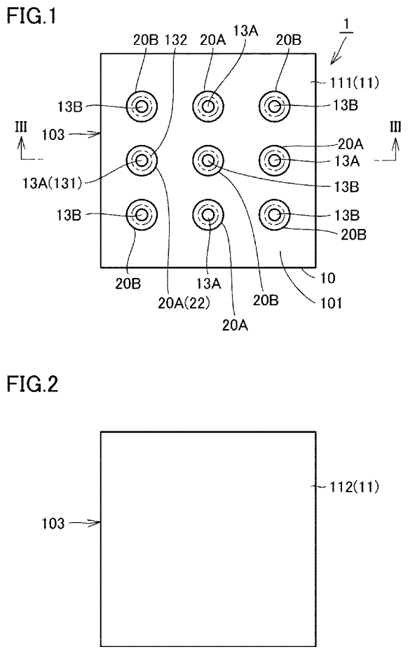

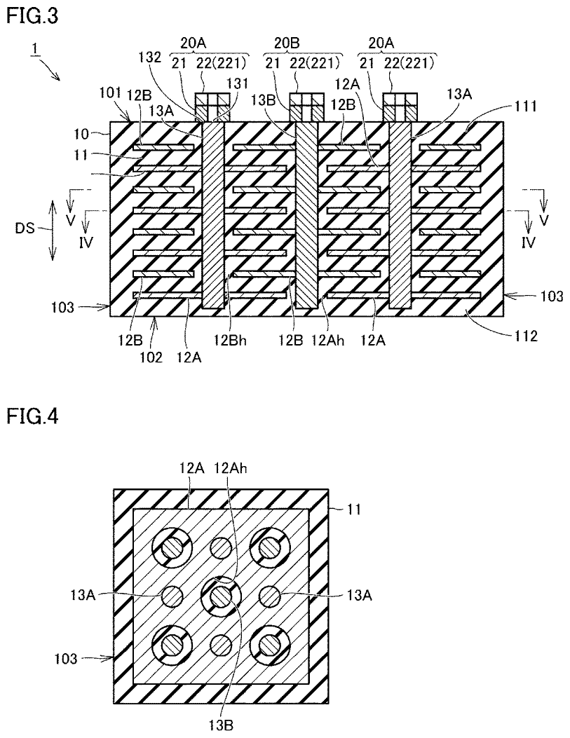

FIG. 1 is a plan view illustrating a multilayer ceramic capacitor according to example embodiment 1 of the present invention as viewed from one side. FIG. 2 is a plan view illustrating the multilayer ceramic capacitor according to example embodiment 1 as viewed from the other side. FIG. 3 is a cross-sectional view of the multilayer ceramic capacitor in FIG. 1 as viewed in the direction of arrows III-III.

As illustrated in FIGS. 1 to 3, the multilayer ceramic capacitor 1 includes a capacitor body 10, a plurality of first outer electrodes 20A, and a plurality of second outer electrodes 20B. In the present example embodiment, the first outer electrode 20A is exemplified as the outer electrode.

The capacitor body 10 may have any shape. In the present example embodiment, the capacitor body 10 has a rectangular or substantially rectangular parallelepiped shape. The rectangular or substantially rectangular parallelepiped shape is an incomplete rectangular or substantially rectangular parallelepiped shape, such as a rectangular or substantially rectangular parallelepiped shape including rounded corners and edges, but a shape that includes six surfaces and can be regarded as a rectangular or substantially rectangular parallelepiped shape.

The capacitor body 10 includes a first main surface 101, a second main surface 102, and peripheral side surfaces 103. The first main surface 101 is a surface of the capacitor body 10 on one side in a lamination direction DS. The second main surface 102 is a surface of the capacitor body 10 on the other side in the lamination direction DS. That is, the second main surface 102 faces away from the first main surface 101 in the capacitor body 10. The first main surface 101 and the second main surface 102 may also have a rectangular or substantially rectangular outer shape as viewed in the lamination direction DS. The peripheral side surfaces 103 connect the first main surface 101 and the second main surface 102 to each other.

The capacitor body 10 may have any dimensions but, as viewed from a first main surface 101 side, the vertical dimension of the rectangle may be, for example, about 0.3 mm or more and about 3.0 mm or less, the horizontal dimension may be about 0.3 mm or more and about 3.0 mm or less, and the dimension in the lamination direction DS may be about 50 μm or more and about 200 μm or less.

FIG. 4 is a cross-sectional view of the multilayer ceramic capacitor in FIG. 3 as viewed in the direction of arrows IV-IV. FIG. 5 is a cross-sectional view of the multilayer ceramic capacitor in FIG. 3 as viewed in the direction of arrows V-V.

As illustrated in FIGS. 1 to 5, the capacitor body 10 includes a plurality of dielectric layers 11, a plurality of first inner electrode layers 12A, a plurality of second inner electrode layers 12B, a plurality of first via conductors 13A, and a plurality of second via conductors 13B.

The plurality of dielectric layers 11 include a first outer layer portion 111 and a second outer layer portion 112. The first outer layer portion 111 is a dielectric layer 11 that is located closest to the first main surface 101 of the plurality of dielectric layers 11. The first outer layer portion 111 forms a portion of the first main surface 101. The second outer layer portion 112 is a dielectric layer 11 that is located closest to the second main surface 102 of the plurality of dielectric layers 11. The second outer layer portion 112 forms an entirety or substantially an entirety of the second main surface 102. Each of the peripheral side surface 103 includes the plurality of dielectric layers 11 including the first outer layer portion 111 and the second outer layer portion 112.

The dielectric layer 11 may be made of any material and may be made of a ceramic material that includes, for example, BaTiO₃, CaTiO₃, SrTiO₃, SrZrO₃, or CaZrO₃ as a main component. It is possible to add, to the main component, an accessory component, selected from, for example, Mn compounds, Fe compounds, Cr compounds, Co compounds, or Ni compounds, that is smaller in amount than the main component.

The plurality of first inner electrode layers 12A and the plurality of second inner electrode layers 12B are alternately laminated in the lamination direction DS with each of the plurality of dielectric layers 11 therebetween. In the multilayer ceramic capacitor 1, the first inner electrode layer 12A and the second inner electrode layer 12B face each other across the dielectric layer 11 to generate electrostatic capacitance. In addition, since the plurality of first inner electrode layers 12A and the plurality of second inner electrode layers 12B are laminated as described above, the multilayer ceramic capacitor 1 becomes a high-capacity density multilayer ceramic capacitor in which a plurality of capacitor functional units are provided at high density.

The plurality of first inner electrode layers 12A are integrally provided in the same layer (see FIG. 4). The first inner electrode layer 12A has a rectangular or substantially rectangular outer shape as viewed in the lamination direction DS. The plurality of first inner electrode layers 12A each include a plurality of first through-holes 12Ah through which the plurality of second via conductors 13B pass.

The plurality of second inner electrode layers 12B are integrally provided in the same layer (see FIG. 5). The second inner electrode layer 12B has a rectangular or substantially rectangular outer shape that is the same or substantially the same as that of the first inner electrode layer 12A as viewed in the lamination direction DS. The plurality of second inner electrode layers 12B each include a plurality of second through-holes 12Bh through which the plurality of first via conductors 13A pass.

The first inner electrode layers 12A and the second inner electrode layers 12B may be made of any material and includes, as a main component, a metal such as, for example, Ni, Cu, Ag, Pd, Pt, Fe, Ti, Cr, Sn, Au, or an alloy including these metals. In the present example embodiment, the first inner electrode layers 12A and the second inner electrode layers 12B include, for example, Ni or an alloy including Ni as a main component.

It is known that hydrogen easily diffuses in Ni or an alloy including Ni. Accordingly, in the present example embodiment, hydrogen can easily diffuse in the first inner electrode layers 12A and the second inner electrode layers 12B. In the description of the present example embodiment, “hydrogen” may be any of hydrogen atoms, hydrogen ions, and hydrogen molecules, for example. In addition, the hydrogen element included in these types of hydrogen may also be any isotope.

The first inner electrode layers 12A and the second inner electrode layers 12B may also include, as a common material, the same ceramic material as the dielectric ceramic included in the dielectric layers 11. In this case, the ratio of the common material included in the first inner electrode layers 12A and the second inner electrode layers 12B is, for example, about 20 vol% or less.

The first inner electrode layer 12A and the second inner electrode layer 12B may have any thickness but may have a thickness of, for example, about 0.3 μm or more and about 1.0 μm or less. The number of the first inner electrode layers 12A and the number of the second inner electrode layers 12B are any numbers, but the sum of them may be, for example, 10 or more and 150 or less.

The plurality of first via conductors 13A are each electrically connected to at least one of the plurality of first inner electrode layers 12A. In the present example embodiment, the plurality of first via conductors 13A are each electrically connected to the plurality of first inner electrode layers 12A.

The plurality of first via conductors 13A extend from the inside of the capacitor body 10 to the first main surface 101. The plurality of first via conductors 13A extend in the lamination direction DS. The plurality of first via conductors 13A are not exposed at the second main surface 102. The plurality of first via conductors 13A pass through the second through-holes 12Bh provided in the plurality of second inner electrode layers 12B. Accordingly, the plurality of first via conductors 13A are insulated from the plurality of second inner electrode layers 12B.

The plurality of second via conductors 13B are each electrically connected to at least one of the plurality of second inner electrode layers 12B. In the present example embodiment, the plurality of second via conductors 13B are each electrically connected to the plurality of second inner electrode layers 12B.

The plurality of second via conductors 13B extend from the inside of the capacitor body 10 to the first main surface 101. The plurality of second via conductors 13B extend in the lamination direction DS. The second via conductors 13B are not exposed at the second main surface 102. The plurality of second via conductors 13B pass through the second through-holes 12Bh provided in the plurality of first inner electrode layers 12A. Accordingly, the plurality of second via conductors 13B are insulated from the plurality of first inner electrode layers 12A.

The plurality of first via conductors 13A and the plurality of second via conductors 13B may have any shape, for example, a cylindrical or substantially cylindrical shape. In this case, the diameters of the first via conductor 13A and the second via conductor 13B are, for example, about 20 μm or more and about 150 μm or less. In addition, the distance between the first via conductor 13A and the second via conductor 13B adjacent to each other, more specifically, the distance between the center of the first via conductor 13A and the center of the second via conductor 13B is, for example, about 50 μm or more and about 500 μm or less.

The first via conductors 13A and the second via conductors 13B may be made of any material and the material may be a metal such as, for example, Ni, Cu, Ag, Pd, Pt, Fe, Ti, Cr, Sn, Au, or an alloy including these metals. In the present example embodiment, the first via conductors 13A and the second via conductors 13B include, for example, Ni or an alloy including Ni as a main component. Accordingly, in the present example embodiment, hydrogen can easily diffuse in the first via conductors 13A and the second via conductors 13B.

The first via conductors 13A and the second via conductors 13B may also include, as a common material, the same ceramic material as the dielectric ceramic included in the dielectric layer 11. In this case, the ratio of the common material included in the first via conductors 13A and the second via conductors 13B is, for example, about 20 vol % or less.

As illustrated in FIGS. 1 and 3, the plurality of first outer electrodes 20A each include the base electrode layer 21 and the plating layer 22. In the present example embodiment, the plurality of first outer electrodes 20A each include the base electrode layer 21 with the same or similar structure and the plating layer 22 with the same or similar structure so as to correspond to the plurality of first via conductors 13A. In addition, the plurality of second outer electrodes 20B that correspond to the plurality of second via conductors 13B also have a structure the same as or similar to that of the first outer electrodes 20A that correspond to the first via conductors 13A. However, at least one of the plurality of first outer electrodes 20A may also include the base electrode layer 21 and the plating layer 22 described below.

The base electrode layers 21 are each provided on a portion of one corresponding first via conductor 13A on the first main surface 101. In addition, the base electrode layer 21 is provided on the first via conductor 13A and the first outer layer portion 111 such that at least a portion of boundaries 132 between the first outer layer portion 111 and the first via conductors 13A on the first main surface 101 is not exposed to the outside. More specifically, the base electrode layer 21 is provided on the first via conductor 13A and the first outer layer portion 111 to prevent all of the boundary 132 from being exposed to the outside. As a result, the base electrode layers 21 have a cylindrical or substantially cylindrical outer shape that extends in the lamination direction DS. The base electrode layers 21 surround surfaces 131 of the first via conductors 13A on which the base electrode layers 21 are not provided on the first main surface 101.

The material of the base electrode layers 21 preferably does not melt if the plating layers 22 are melted when the multilayer ceramic capacitor 1 is mounted. As a result, the base electrode layers 21 are preferably made of a material with a higher melting point than the plating layers 22. In the present example embodiment, for example, the base electrode layers 21 include nickel (Ni), an alloy including Ni, copper (Cu), or an alloy including Cu as a main component.

The base electrode layers 21 may be either base plating layers or baked electrode layers. When the base electrode layers 21 base plating layers in the present example embodiment, the base electrode layers 21 include, for example, Ni or Cu as a main component. When the base electrode layers 21 are baked electrode layers, the base electrode layers 21 may include a ceramic material. The ceramic material may be, for example, a glassy (amorphous) material. The methods for providing such base electrode layers 21 will be described later.

The thickness of the base electrode layer 21 in the lamination direction DS is not particularly limited. The thickness of the base electrode layer 21 only needs to be, for example, about 1 μm or more and about 10 μm or less. The overall dimension of the base electrode layer 21 of the first outer electrode 20A in the lamination direction DS can be adjusted by the thickness of the base electrode layer 21. As the overall dimension of the base electrode layer 21 of the first outer electrode 20A in the lamination direction DS is greater, the multilayer ceramic capacitor 1 can be more firmly connected to an electronic component, such as a semiconductor package component. This is because, when the multilayer ceramic capacitor 1 is mounted on an electronic component, an underfill resin can be more easily injected into a portion between the first main surface 101 and the electronic component.

The plating layers 22 are provided on the base electrode layers 21 such that the surfaces 131 of the first via conductors 13A on which the base electrode layers 21 are not provided are exposed to the outside on the first main surface 101. In the present example embodiment, the plating layers 22 are provided on surfaces of the base electrode layers 21 that face the lamination direction DS. The plating layer 22 has a cylindrical or substantially cylindrical outer shape that extends in the lamination direction DS. The plating layers 22 surround the surfaces 131 as viewed in the lamination direction DS.

In the present example embodiment, the plating layers 22 are not in contact with the first main surface 101. However, the plating layers 22 may be in contact with the first main surface 101 as long as at least a portion of the surfaces 131 is exposed to the outside. Specifically, the plating layers 22 may be in contact with the first outer layer portion 111, the first via conductors 13A, or both of them.

In addition, the plating layers 22 are provided only on the surfaces of the base electrode layers 21 that faces the lamination direction DS. However, the plating layers 22 may also be provided on the side surfaces of the base electrode layers 21 that face the direction orthogonal or substantially orthogonal to the lamination direction DS, as long as at least a portion of the surfaces 131 is exposed to the outside. In addition, the plating layers 22 may also be provided on the outer peripheral side surfaces or the inner peripheral side surfaces of the cylindrical base electrode layers 21 or both of them. In addition, the plating layers 22 may also be provided so as to cover the entirety or substantially the entirety of the base electrode layers 21 such that the base electrode layers 21 are not exposed to the outside.

The plating layer 22 includes at least an outermost plating layer 221. The outermost plating layer 221 is the outermost layer of the first outer electrode 20A. In the present example embodiment, the plating layer 22 includes only the outermost plating layer 221. The plating layer 22 may further include one or more base plating layers located between the outermost plating layer 221 and the base electrode layer 21.

The multilayer ceramic capacitor 1 can preferably be mounted on an electronic component by, for example, reflow soldering or heating joint with flux. From this perspective, in the present example embodiment, the outermost plating layer 221 has a low melting point. Specifically, for example, the outermost plating layer 221 includes Sn or an alloy including Sn as a main component. The alloy including Sn is, for example, a SnAg alloy or a SnBi alloy. The materials of the base plating layer are not particularly limited but may be, for example, Cu, Ni, or Au.

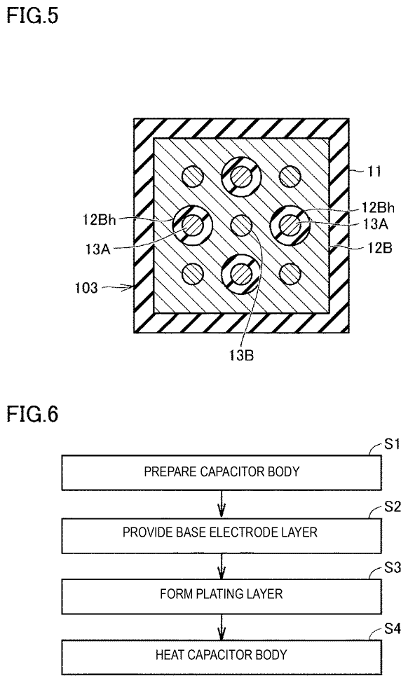

Next, an example of a method of manufacturing the multilayer ceramic capacitor according to example embodiment 1 of the present invention will be described. FIG. 6 is a flowchart illustrating the example of the method of manufacturing the multilayer ceramic capacitor according to example embodiment 1.

As illustrated in FIG. 6, the method of manufacturing the multilayer ceramic capacitor according to present example embodiment 1 includes a process S1 of preparing the capacitor body, a process S2 of providing the base electrode layers, a process S3 of forming the plating layers, and a process S4 of heating the capacitor body. The process S1 and the process S2 may also be performed concurrently, but the process S1, the process S2, the process S3, and the process S4 are performed in this order.

First, in the process S1 of preparing the capacitor body, the capacitor body 10 is prepared (see FIGS. 1 to 5). The specific method of preparing the capacitor body 10 is not particularly limited. In the process S1 according to the present example embodiment, first, a plurality of ceramic green sheets that correspond to the dielectric layers 11 and conductive paste layers that correspond to the plurality of first inner electrode layers 12A and the plurality of second inner electrode layers 12B are laminated in a predetermined pattern to form a multilayer body. A plurality of through-holes that pass through the multilayer body in the lamination direction are formed by laser irradiation, for example. Then, the plurality of through-holes are filled with a conductive paste. As a result, a plurality of columnar conductive pastes that correspond to the plurality of first via conductors 13A and the plurality of second via conductors 13B of the capacitor body 10 are provided in the multilayer body. In addition, the ceramic green sheets that correspond to at least a portion of the second outer layer portion 112 are further laminated on the multilayer body so as to cover one side of these columnar conductive pastes. As a result, at one surface (the surface that corresponds to the second main surface 102) of the multilayer body, the plurality of columnar conductive pastes are not exposed.

Then, the multilayer body in which the plurality of columnar conductive pastes and the outer layer ceramic green sheets are provided is fired. As a result, the capacitor body 10 is formed.

In the process S2 of providing the base electrode layer, the base electrode layer 21 is provided on each of the plurality of first via conductors 13A and each of the plurality of second via conductors 13B on the first main surface 101 (see FIGS. 1 to 5).

When the base plating layers are provided as the base electrode layers 21, for example, plating resists are used. In at least the first via conductors 13A and the second via conductors 13B, plating resists are formed on at least the surfaces 131 (see FIG. 3) by using a patterning method, for example. Then, in a state in which the plating resists are formed, the base plating layers (base electrode layers 21) are provided for each of the first via conductors 13A and each of the second via conductors 13B by using, for example, an electrolytic plating method or the like. After the base plating layer (base electrode layer 21) is provided, the plating resists are removed.

When baked electrode layers are provided as the base electrode layers 21, conductive paste surface layers that correspond to the baked electrode layers (base electrode layers 21) are provided so as to cover the first via conductors 13A on the first main surface 101 of the capacitor body 10, and the conductive paste surface layers are further fired to form the baked electrode layers (base electrode layers 21). The conductive paste surface layers may also be provided on the multilayer body for which the capacitor body 10 is not yet fired. In this case, the multilayer body and the conductive paste surface layers can be concurrently fired.

In the process S3 of forming the plating layers, the plating layers 22 are formed on the base electrode layers 21 (see FIGS. 1 to 5).

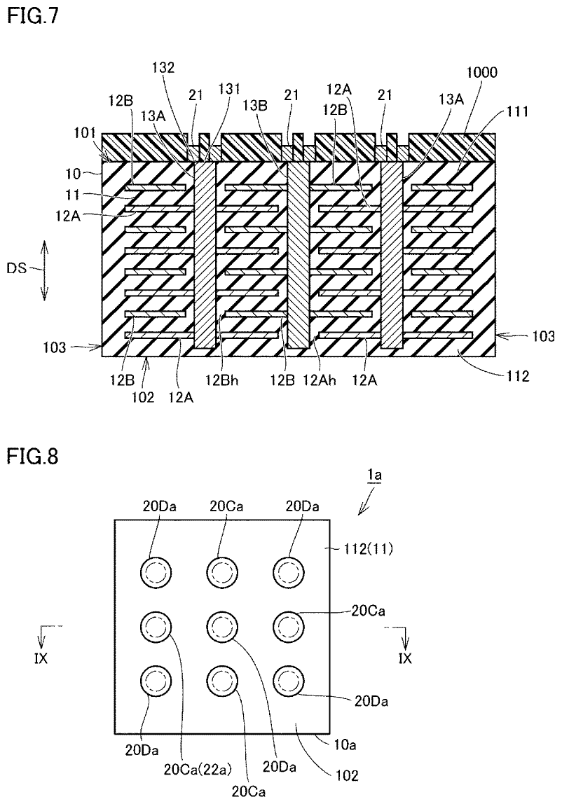

FIG. 7 is a cross-sectional view schematically illustrating the process of forming the plating layers in example embodiment 1. As illustrated in FIG. 7, in the process S3 of forming the plating layers, plating resists 1000 are formed on at least the surfaces 131 by using a patterning method, for example. In the present example embodiment, the plating resists 1000 are provided so as to cover the side surfaces of the base electrode layers 21 that face a direction orthogonal or substantially orthogonal to the lamination direction DS. The plating resists may also be provided so as to cover the entirety or substantially the entirety of first main surface 101. Then, in a state in which the plating resists are formed, the plating layers 22 are provided on the base electrode layers 21 by using an electrolytic plating method or the like, for example. After the plating layers 22 are formed, the plating resists 1000 are removed.

In the process S4 of heating the capacitor body, after forming the plating layers 22, the capacitor body 10, the first outer electrodes 20A, and the second outer electrodes 20B are heated to diffuse hydrogen included in the plurality of dielectric layers 11 in the first via conductors 13A and discharge the hydrogen to the outside through the first main surface 101. At this time, the capacitor body 10 is heated in a temperature range lower than the melting point of the material of the plating layer 22. In the present example embodiment, since the outermost plating layer 221 includes Sn, for example, the capacitor body 10 is heated in a temperature range of about 230° C. or lower. The lower limit of the temperature range is not particularly restricted but is preferably, for example, about 100° C. or higher at which moisture can be evaporated simultaneously.

Here, the diffusion path through which hydrogen having entered from the outside escapes to the outside again through the first main surface 101 during manufacturing of the multilayer ceramic capacitor 1 according to the present example embodiment will be described.

First, when the plating layers 22 and the base plating layers are formed, hydrogen is generated due to side reactions of plating. This hydrogen enters the insides of the first via conductors 13A and the second via conductors 13B through the first via conductors 13A and the second via conductors 13B on the first main surface 101. In the present example embodiment, since the first via conductors 13A, the second via conductors 13B, the first inner electrode layers 12A, and the second inner electrode layers 12B include, for example, Ni or an alloy including Ni as a main component, hydrogen easily diffuses in these conductors and layers. In addition, the first via conductors 13A, the second via conductors 13B, the first inner electrode layers 12A, and the second inner electrode layers 12B absorb the hydrogen. The hydrogen further diffuses from the first via conductors 13A, the second via conductors 13B, the first inner electrode layers 12A, and the second inner electrode layers 12B into the dielectric layers 11. The hydrogen in the dielectric layers 11 can reduce the insulation resistance of the multilayer ceramic capacitor 1.

The hydrogen that has diffused in the dielectric layers 11 as described above attempts to escape to the outside through the first via conductors 13A and the second via conductors 13B that include Ni or an alloy including Ni as a main component. At this time, in the present example embodiment, the outermost plating layers 221 of the plating layers 22 reduces or prevents the hydrogen from escaping to the outside. This is because the plating layer 22 includes, for example, Sn in the present example embodiment. Hydrogen is less likely to penetrate Sn than Cu and Ni. This is because the crystal structure of Cu and Ni is a face-centered cubic structure, while the crystal structure of Sn is a hexagonal close-packed structure. In addition, for example, when the material of the base electrode layers 21 is copper (Cu) or an alloy including Cu, the material further reduces or prevents the hydrogen from escaping to the outside. This is because the hydrogen is less likely to penetrate Cu than Ni. The smaller the heat of dissolution of hydrogen into metal, the greater the solubility of hydrogen in the metal. The heat of dissolution of hydrogen into Cu and Ni are, for example, +42 (kJ/mol) and +16 (kJ/mol), respectively.

However, in the present example embodiment, the surfaces 131 of the first via conductors 13A (and the second via conductors 13B) are exposed to the outside on the first main surface 101. In addition, the hydrogen easily diffuses in Ni or an alloy including Ni. As a result, the hydrogen can escape to the outside again through the surfaces 131 after diffusing in the first via conductors 13A (and the second via conductors 13B) that include Ni or an alloy including Ni as a main component. Accordingly, in the present example embodiment, the hydrogen can be discharged to the outside more efficiently by promoting the diffusion in the first via conductors 13A and the second via conductors 13B in the heating process S4 described above.

As described above, the multilayer ceramic capacitor according to example embodiment 1 of the present invention includes the capacitor body 10 and the first outer electrodes 20A. The capacitor body 10 includes the plurality of dielectric layers 11, the plurality of first inner electrode layers 12A, the plurality of second inner electrode layers 12B, and the first via conductors 13A. The plurality of first inner electrode layers 12A and the plurality of second inner electrode layers 12B are alternately laminated in the lamination direction DS with each of the plurality of dielectric layers 11 therebetween. The first via conductors 13A are electrically connected to the plurality of first inner electrode layers 12A. The first via conductors 13A extend from the inside of the capacitor body 10 to the first main surface 101 that is a surface of the capacitor body 10 on one side in the lamination direction DS. The first outer electrodes 20A each include the base electrode layer 21 and the plating layer 22. The base electrode layers 21 are provided on a portion of the first via conductors 13A on the first main surface 101. The plating layers 22 are provided on the base electrode layers 21 such that the surfaces 131 of the via conductors 13A on which the base electrode layers 21 are not provided are exposed to the outside on the first main surface 101.

In the structure described above, the hydrogen that has diffused in the first via conductors 13A and entered the dielectric layers 11 during forming of the plating layers 22 diffuses in the first via conductors 13A again and reaches the first main surface 101. Then, the hydrogen can easily escape to the outside through the surfaces 131 of the first via conductors 13A that are exposed to the outside. Accordingly, in the multilayer ceramic capacitor 1 including the first via conductors 13A, reduction in the insulation resistance due to the hydrogen in the dielectric layers 11 can be reduced or prevented.

In addition, in the present example embodiment, the plurality of dielectric layers 11 include the first outer layer portion 111 that defines the first main surface 101. The base electrode layers 21 are provided on the first via conductors 13A and the first outer layer portion 111 such that at least part of the boundaries 132 between the first outer layer portion 111 and the first via conductors 13A on the first main surface 101 is not exposed to the outside.

In the structure described above, moisture can be reduced or prevented from entering the inside of the capacitor body 10 through the boundaries described above. As a result, reduction in the insulation resistance of the multilayer ceramic capacitor 1 due to the moisture in the capacitor body 10 can be reduced or prevented.

In addition, in the present example embodiment, the base electrode layers 21 are provided on the first via conductors 13A and the first outer layer portion 111 to prevent all of the boundaries 132 from being exposed to the outside. In the structure, moisture can be further reduced or prevented from entering the inside of the capacitor body 10 through the boundaries described above.

In addition, in the present example embodiment, the base electrode layer 21 may include nickel (Ni), for example. The hydrogen diffuses relatively easily in Ni. Accordingly, in the structure, the hydrogen that has diffused in the first via conductors 13A and reached the first main surface 101 can further diffuse in the base electrode layers 21 and easily escape to the outside.

In addition, in the present example embodiment, the base electrode layers 21 may include copper (Cu), for example. When the thickness of the base electrode layers 21 in the lamination direction DS is relatively small, the hydrogen can diffuse relatively easily in Cu of the base electrode layers 21. Accordingly, in the structure described above, the hydrogen that has diffused in the first via conductors 13A and reached the first main surface 101 can further diffuse in the base electrode layers 21 and easily escape to the outside. In addition, when the thickness of the base electrode layers 21 in the lamination direction DS is relatively great, the overall dimension of the first outer electrodes 20A in the lamination direction DS also increases. As a result, when the multilayer ceramic capacitor 1 is mounted on an electronic component by joining the first outer electrodes 20A to an electronic component, an underfill resin can be easily injected into a portion between the first main surface 101 and the electronic component. When the thickness of the base electrode layers 21 in the lamination direction DS is relatively large, the hydrogen is less likely to diffuse in Cu of the base electrode layers 21. However, as described above, the hydrogen can easily escape from the surfaces 131 of the first via conductors 13A that are exposed to the outside.

In addition, in the present example embodiment, the base electrode layers 21 may include a ceramic material. In the structure, the adhesion between the base electrode layers 21 and the first outer layer portion 111 can be improved, and moisture can be further reduced or prevented from entering the inside of the capacitor body 10 through the boundaries 132. The structure reduces or prevents the hydrogen from escaping through the boundaries 132. However, as described above, the hydrogen can easily escape through the surfaces 131 of the first via conductors 13A that are exposed to the outside.

In addition, in the present example embodiment, the plating layers 22 each include the outermost plating layer 221 that is the outermost layer of the first outer electrode 20A and includes tin (Sn), for example.

In the structure described above, the multilayer ceramic capacitor 1 can be easily mounted by melting the outermost plating layers 221 including Sn and performing reflow soldering. The hydrogen is relatively less likely to diffuse in Sn. However, as described above, the hydrogen can easily escape through the surfaces 131 of the first via conductors 13A that are exposed to the outside.

In addition, in the present example embodiment, the plurality of dielectric layers 11 include the second outer layer portion 112 that define the entirety or substantially the entirety of the second main surface 102, which is a surface of the capacitor body 10 on the other side in the lamination direction DS.

In the structure described above, the first via conductors 13A are not exposed at the second main surface 102. Accordingly, moisture can be reduced or prevented from entering the inside of the capacitor body 10 through the boundaries between the second outer layer portion 112 and the first via conductors 13A on the second main surface 102. The structure reduces or prevents the hydrogen from escaping from a second main surface 102 side. However, as described above, the hydrogen can easily escape through the surfaces 131 of the first via conductors 13A that are exposed to the outside.

In addition, for example, the method of manufacturing a multilayer ceramic capacitor according to example embodiment 1 includes preparing (S1) the capacitor body 10 that includes the plurality of dielectric layers 11, the plurality of first inner electrode layers 12A and the plurality of second inner electrode layers 12B, and the first via conductors 13A, in which the plurality of first inner electrode layers 12A and the plurality of second inner electrode layers 12B are alternately laminated in the lamination direction DS with each of the plurality of dielectric layers 11 therebetween, and the first via conductors 13A are electrically connected to the plurality of first inner electrode layers 12A and extend from the inside of the capacitor body 10 to the first main surface 101 that is the surface of the capacitor body 10 on one side in the lamination direction DS, providing (S2) the base electrode layers 21 on a portion of the first via conductors 13A on the first main surface 101, forming (S3) the plating layers 22 on the base electrode layers 21 such that the surfaces 131 of the via conductors 13A on which the base electrode layers 21 are not provided are exposed to the outside on the first main surface 101, and heating (S4) the capacitor body 10 to diffuse the hydrogen included in the plurality of dielectric layers 11 in the first via conductors 13A and discharge the hydrogen to the outside through the first main surface 101, after forming (S3) the plating layers 22.

In the structure described above, during forming (S3) of the plating layers 22, the hydrogen that has diffused in the first via conductors 13A and entered the dielectric layers 11, diffuses to the first main surface 101 via the first via conductors 13A due to the heating (S4). Then, the hydrogen can be easily discharged to the outside through the first main surface 101. Accordingly, in the multilayer ceramic capacitor 1 including the first via conductors 13A, reduction in the insulation resistance due to the moisture in the dielectric layers 11 can be reduced.

In addition, during heating (S4) of the capacitor body 10 after forming the plating layers 22, the capacitor body 10 is heated at a temperature range lower than the melting point of the material of the plating layers 22.

In the structure described above, the heating can reduce or prevent changes in the outer shape of the plating layers 22. Consequently, reduction in the mounting performance of the multilayer ceramic capacitor 1 can be reduced or prevented.

Next, am example of a multilayer ceramic capacitor according to example embodiment 2 of the present invention will be described. The multilayer ceramic capacitor according to example embodiment 2 partially differs from the multilayer ceramic capacitor 1 according to example embodiment 1 of the present invention in the structure of the second main surface. Accordingly, the components and the advantageous effects the same as or similar to those of the multilayer ceramic capacitor 1 according to example embodiment 1 will not be described.

FIG. 8 is a plan view of the multilayer ceramic capacitor according to example embodiment 2 as viewed from a second main surface side. FIG. 9 is a cross-sectional view of the multilayer ceramic capacitor in FIG. 8 as viewed in the direction of arrows IX-IX.

As illustrated in FIGS. 8 and 9, in a multilayer ceramic capacitor 1a according to example embodiment 2 of the present invention, the capacitor body 10a further includes other first outer electrodes 20Ca. First via conductors 13Aa extend from the inside of the capacitor body 10a to the second main surface 102, which is a surface of the capacitor body 10a on the other side in the lamination direction DS. The other first outer electrodes 20Ca are provided on the first via conductors 13Aa on the second main surface 102.

In the structure described above, other electronic components can be connected to the second main surface 102 side of the multilayer ceramic capacitor 1a. In the present example embodiment, the other first outer electrodes 20Ca are exemplified as the other outer electrodes. In addition, second via conductors 13Ba also extend from the inside of the capacitor body 10a to the second main surface 102, which is a surface of the capacitor body 10a on the other side in the lamination direction DS. Other second outer electrodes 20Da are provided on the second via conductors 13Ba on the second main surface 102.

In addition, in the present example embodiment, the other first outer electrodes 20Ca are provided such that the first via conductors 13Aa are not exposed to the outside on the second main surface 102.

In the structure described above, the other first outer electrodes 20Ca can be easily provided. When the hydrogen does not easily diffuse in base electrode layers 21a because the base electrode layers 21a of the other first outer electrodes 20Ca include a metal other than Ni as a main component, the structure described above reduces or prevents the hydrogen from escaping through the second main surface 102 side. However, also in the present example embodiment, the hydrogen can easily escape from the surfaces 131 of the first via conductors 13Aa that are exposed to the outside on the first main surface 101 side. In addition, the other second outer electrodes 20Da are also provided such that the second via conductors 13Ba are not exposed to the outside on the second main surface 102.

The multilayer ceramic capacitor 1a according to the present example embodiment includes the plurality of other first outer electrodes 20Ca and the plurality of other second outer electrodes 20Da. The plurality of other first outer electrodes 20Ca include base electrode layers 21a with the same or similar structure and plating layers 22a with the same or similar structure so as to correspond to the plurality of first via conductors 13Aa. In addition, the plurality of other second outer electrodes 20Da that correspond to the plurality of second via conductors 13Ba, respectively, also have a structure the same as or similar to that of the other first outer electrodes 20Ca that correspond to the first via conductors 13Aa. However, the structures of these outer electrodes may differ from each other. In the plurality of other first outer electrodes 20Ca and the plurality of other second outer electrodes 20Da, when the base electrode layers 21a include Ni, for example, the hydrogen can easily escape from the side surfaces of the base electrode layers 21a.

In the multilayer ceramic capacitor 1a according to the present example embodiment, the base electrode layers 21a of the plurality of other first outer electrodes 20Ca and the plurality of other second outer electrodes 20Da can be provided by a method that is the same as or similar to the method of providing the base electrode layers 21 on the first main surface 101 side in the process S2 of providing the base electrode layers 21. Here, when the base electrode layers 21a are the base plating layers, plating resists do not necessarily need to be formed on the second main surface 102.

Next, a multilayer ceramic capacitor according to example embodiment 3 of the present invention will be described. The multilayer ceramic capacitor according to example embodiment 3 partially differs from the multilayer ceramic capacitor 1a according to example embodiment 2 of the present invention mainly in the structure of the other outer electrodes. Accordingly, the components and the advantageous effects the same as or similar to those of the multilayer ceramic capacitor 1a according to example embodiment 2 will not be described.

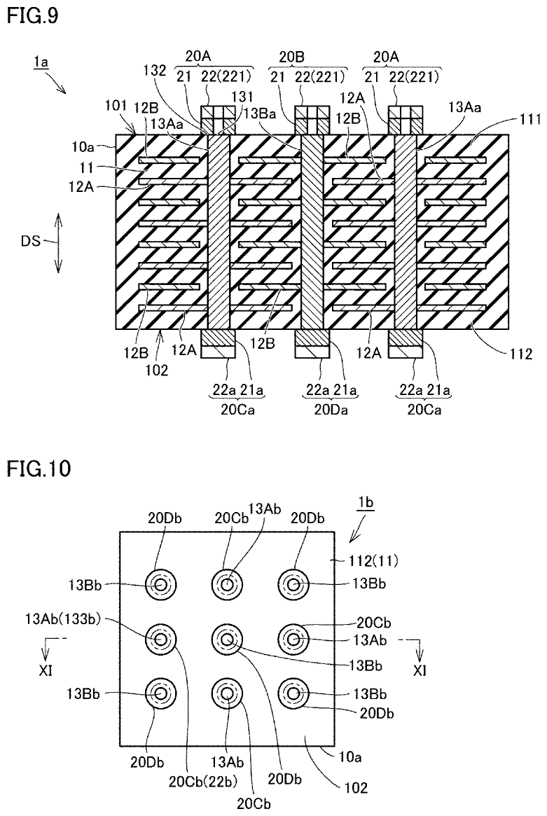

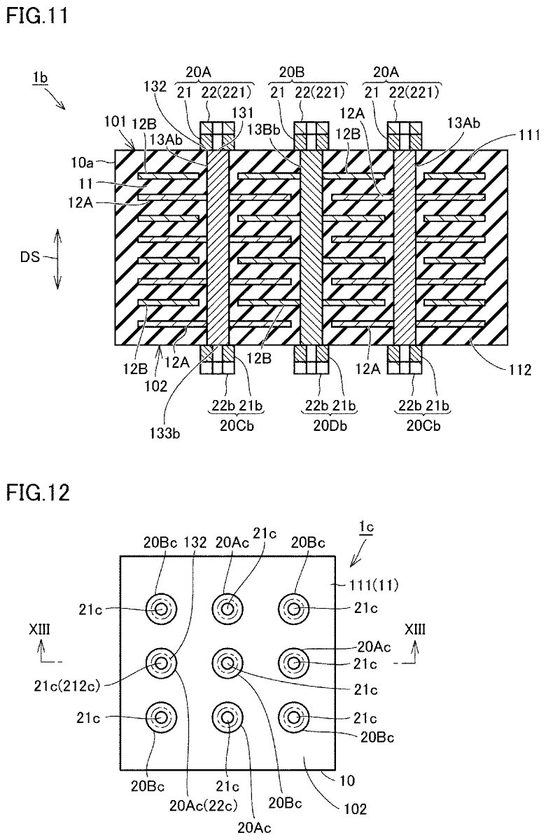

FIG. 10 is a plan view of the multilayer ceramic capacitor according to example embodiment 3 as viewed from the second main surface side. FIG. 11 is a cross-sectional view of the multilayer ceramic capacitor in FIG. 10 as viewed in the direction of arrows XI-XI.

As illustrated in FIGS. 10 and 11, in a multilayer ceramic capacitor 1b according to example embodiment 3 of the present invention, other first outer electrodes 20Cb are provided such that first via conductors 13Ab are exposed to the outside on the second main surface 102.

In the structure described above, the hydrogen can also easily escape from surfaces 133b of the first via conductors 13Ab that are exposed to the outside on the second main surface 102. It should be noted that other second outer electrodes 20Db are also provided such that second via conductors 13Bb are exposed to the outside on the second main surface 102.

In addition, in the present example embodiment, a base electrode layer 21b and a plating layer 22b of each of the plurality of other first outer electrodes 20Cb and each of the plurality of other second outer electrodes 20Db disposed on the second main surface 102 side have a structure the same as or similar to that of the base electrode layer 21 and a structure similar to the plating layer 22 disposed on the first main surface 101 side, respectively. However, the structures of these outer electrodes may also differ from each other.

Next, a multilayer ceramic capacitor according to example embodiment 4 of the present invention and a manufacturing method thereof will be described. The multilayer ceramic capacitor according to example embodiment 4 partially differs from the multilayer ceramic capacitor 1 according to example embodiment 1 of the present invention mainly in the structure of outer electrodes. Accordingly, the components and the advantageous effects the same as or similar to those of the multilayer ceramic capacitor 1 according to example embodiment 1 and the manufacturing method thereof will not be described.

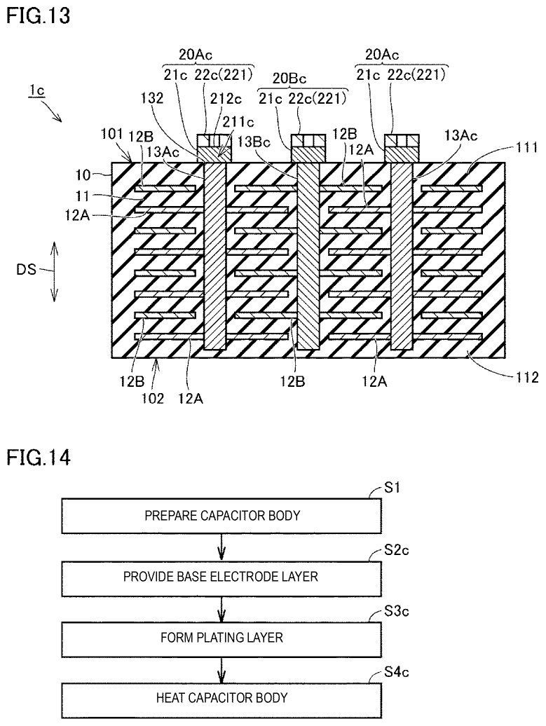

FIG. 12 is a plan view of the multilayer ceramic capacitor according to example embodiment 4 as viewed from the first main surface side. FIG. 13 is a cross-sectional view of the multilayer ceramic capacitor in FIG. 12 as viewed in the direction of arrows XIII-XIII.

As illustrated in FIGS. 12 and 13, in a multilayer ceramic capacitor 1c according to example embodiment 4 of the present invention, base electrode layers 21c are provided such that first via conductors 13Ac are not exposed to the outside on the first main surface 101. In addition, plating layers 22c are provided on the base electrode layers 21c such that at least a portion of portions 211c of the base electrode layers 21c that are aligned with the first via conductors 13Ac in the lamination direction DS is exposed to the outside in the lamination direction DS.

In the structure described above, the hydrogen that has diffused in the first via conductors 13Ac and entered the dielectric layers 11 during forming of the plating layers 22c diffuses in the first via conductors 13Ac and the base electrode layers 21c in the lamination direction DS and quickly reaches surfaces 212c of the base electrode layers 21c, exposed to the outside, that faces the lamination direction DS. Then, the hydrogen can easily escape through the surfaces 212c. Accordingly, in the multilayer ceramic capacitor 1 including the first via conductors 13Ac, reduction in the insulation resistance due to the hydrogen in the dielectric layers 11 can be reduced or prevented. As viewed in the lamination direction DS, the plating layers 22c are disposed so as to surround the surfaces 212c described above. In the present example embodiment, the side surfaces of the base electrode layers 21c are also exposed to the outside. As a result, the hydrogen can escape through the side surfaces of the base electrode layers 21c. Since the hydrogen must pass through the base electrode layers 21c when escaping to the outside, the base electrode layers 21c preferably includes, for example, Ni in which the hydrogen can easily diffuse.

In addition, in the present example embodiment, the plating layers 22c are provided such that at least a portion thereof is aligned with the first via conductors 13Ac in the lamination direction DS. In the structure, the conductive path from the first via conductors 13Ac to the plating layers 22c can be reduced or prevented from elongating. More specifically, the plating layers 22c are located so as to cover the boundaries 132 between the first via conductors 13Ac and the first outer layer portion 111 on the first main surface 101 (see FIG. 12).

In addition, in the present example embodiment, the base electrode layers 21c are provided on the first via conductors 13Ac and the first outer layer portion 111 to prevent all of the boundaries 132 between the first outer layer portion 111 and the first via conductors 13Ac on the first main surface 101 from being exposed to the outside.

In the structure described above, moisture can be reduced or prevented from entering the inside of the capacitor body 10 through the boundaries 132. As a result, reduction in the insulation resistance of the multilayer ceramic capacitor 1 due to the moisture in the capacitor body 10 can be reduced or prevented.

In the present example embodiment, a plurality of first outer electrodes 20Ac each include the base electrode layer 21c with the same or similar structure and the plating layer 22c with the same or structure so as to correspond to the plurality of first via conductors 13Ac. In addition, a plurality of second outer electrodes 20Bc that correspond to a plurality of second via conductors 13Bc each have a structure the same as or similar to that of the first outer electrode 20Ac that corresponds to the first via conductor 13Ac.

Next, an example of a method of manufacturing the multilayer ceramic capacitor according to example embodiment 4 of the present invention will be described. FIG. 14 is a flowchart illustrating the method of manufacturing the multilayer ceramic capacitor according to example embodiment 4. As illustrated in FIGS. 12 to 14, the method of manufacturing the multilayer ceramic capacitor according to example embodiment 4 includes providing (S2c) the base electrode layers 21c such that the first via conductors 13Ac are not exposed to the outside on the first main surface 101, forming (S3c) the plating layers 22c on the base electrode layers 21c such that at least a portion of the portions 211c of the base electrode layers 21c that are aligned with the first via conductors 13Ac in the lamination direction DS is exposed to the outside in the lamination direction DS, and heating (S4c) the capacitor body 10 to diffuse the hydrogen included in the plurality of dielectric layers 11 in the first via conductors 13Ac and the base electrode layers 21c in the lamination direction DS and discharge the hydrogen to the outside, after forming (S3c) the plating layers 22c.

In the structure described above, during forming (S3c) of the plating layers 22c, the hydrogen that has diffused in the first via conductors 13Ac and entered the dielectric layers 11 diffuses in the first via conductors 13Ac and the base electrode layers 21c in the lamination direction DS due to the heating (S4c), thus quickly diffusing to surfaces of the base electrode layers 21c that face the lamination direction DS. In addition, the hydrogen can be easily discharged to the outside through the surfaces. Accordingly, in the multilayer ceramic capacitor including the first via conductors 13Ac, reduction in the insulation resistance due to the hydrogen in the dielectric layers 11 can be reduced or prevented.

In the process S2c of providing the base electrode layers in the present example embodiment, when a base plating layers are provided as the base electrode layers 21c, plating resists do not need to be used. This is because the first via conductors 13Ac do not need to be exposed to the outside.

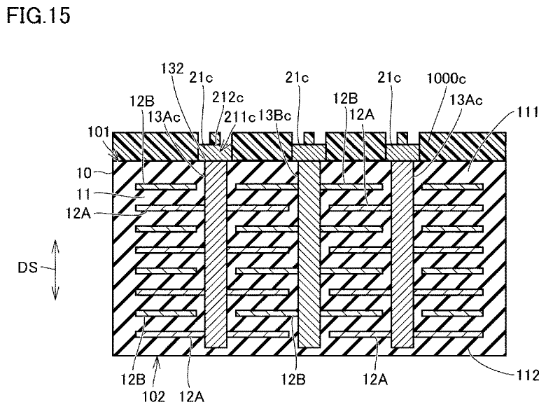

FIG. 15 is a cross-sectional view schematically illustrating a process of forming the plating layers in example embodiment 4. As illustrated in FIG. 15, in the process S3c of forming the plating layers, plating resists 1000c are formed on at least the surfaces 212c by a patterning method.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor body; and
an outer electrode; wherein
the capacitor body includes:
a plurality of dielectric layers;
a plurality of first inner electrode layers and a plurality of second inner electrode layers alternately laminated in a lamination direction with the plurality of dielectric layers therebetween; and
a via conductor, electrically connected to the plurality of first inner electrode layers and extending from an inside of the capacitor body to a first main surface of the capacitor body on one side in the lamination direction;
the outer electrode includes a base electrode layer on a portion of the via conductor on the first main surface; and
a plating layer is provided on the base electrode layer such that a surface of the via conductor on which the base electrode layer is not provided is exposed to an outside on the first main surface.

2. The multilayer ceramic capacitor according to claim 1, wherein
the plurality of dielectric layers include a first outer layer portion defining the first main surface; and
the base electrode layer is provided on the via conductor and the first outer layer portion such that at least a portion of a boundary between the first outer layer portion and the via conductor on the first main surface is not exposed to the outside.

3. The multilayer ceramic capacitor according to claim 2, wherein the base electrode layer is provided on the via conductor and the first outer layer portion to prevent all of the boundary from being exposed to the outside.

4. The multilayer ceramic capacitor according to claim 1, wherein the base electrode layer includes nickel.

5. The multilayer ceramic capacitor according to claim 1, wherein the plating layer includes an outermost plating layer defining an outermost layer of the outer electrode and includes tin.

6. The multilayer ceramic capacitor according to claim 1, wherein the plurality of dielectric layers include a second outer layer portion defining an entirety or substantially an entirety of a second main surface of the capacitor body on another side in the lamination direction.

7. The multilayer ceramic capacitor according to claim 1, wherein
the capacitor body further includes another outer electrode;
the via conductor extends from an inside of the capacitor body to a second main surface of the capacitor body on another side in the lamination direction; and
the other outer electrode is provided on the via conductor on the second main surface.

8. The multilayer ceramic capacitor according to claim 7, wherein the other outer electrode is provided on the second main surface such that the via conductor is not exposed to the outside.

9. The multilayer ceramic capacitor according to claim 7, wherein the other outer electrode is provided such that the via conductor is exposed to the outside on the second main surface.

10. A multilayer ceramic capacitor comprising:
a capacitor body; and
an outer electrode; wherein
the capacitor body includes:
a plurality of dielectric layers;
a plurality of first inner electrode layers and a plurality of second inner electrode layers alternately laminated in a lamination direction with the plurality of dielectric layers therebetween; and
a via conductor electrically connected to the plurality of first inner electrode layers and extending from an inside of the capacitor body to a first main surface of the capacitor body on one side in the lamination direction;
the outer electrode includes a base electrode layer provided such that the via conductor is not exposed to an outside on the first main surface; and
a plating layer provided on the base electrode layer such that at least a portion of the base electrode layer that is aligned with the via conductor in the lamination direction is exposed to the outside in the lamination direction.

11. The multilayer ceramic capacitor according to claim 10, wherein at least a portion of the plating layer is aligned with the via conductor in the lamination direction.

12. The multilayer ceramic capacitor according to claim 10, wherein
the plurality of dielectric layers include a first outer layer portion defining the first main surface; and
the base electrode layer is provided on the via conductor and the first outer layer portion to prevent all of the boundary between the first outer layer portion and the via conductor on the first main surface from being exposed to the outside.

13. The multilayer ceramic capacitor according to claim 10, wherein the base electrode layer includes nickel.

14. The multilayer ceramic capacitor according to claim 10, wherein the plating layer includes an outermost plating layer defining an outermost layer of the outer electrode and includes tin.

15. The multilayer ceramic capacitor according to claim 10, wherein the plurality of dielectric layers include a second outer layer portion defining an entirety or substantially an entirety of a second main surface of the capacitor body on another side in the lamination direction.

16. The multilayer ceramic capacitor according to claim 10, wherein
the capacitor body further includes another outer electrode;
the via conductor extends from an inside of the capacitor body to a second main surface of the capacitor body on another side in the lamination direction; and
the other outer electrode is provided on the via conductor on the second main surface.

17. The multilayer ceramic capacitor according to claim 16, wherein the other outer electrode is provided on the second main surface such that the via conductor is not exposed to the outside.

18. A method of manufacturing a multilayer ceramic capacitor, the method comprising:
preparing a capacitor body that includes:
a plurality of dielectric layers;
a plurality of first inner electrode layers and a plurality of second inner electrode layers; and
a via conductor; wherein
the plurality of first inner electrode layers and the plurality of second inner electrode layers are alternately laminated in a lamination direction with the plurality of dielectric layers therebetween, and the via conductor is electrically connected to the plurality of first inner electrode layers and extends from an inside of the capacitor body to a first main surface that is a surface of the capacitor body on one side in the lamination direction;
providing a base electrode layer on a portion of the via conductor on the first main surface;
forming a plating layer on the base electrode layer such that a surface of the via conductor on which the base electrode layer is not provided is exposed to an outside on the first main surface; and
heating the capacitor body to diffuse hydrogen included in the plurality of dielectric layers in the via conductor and discharge the hydrogen to the outside through the first main surface, after forming the plating layer.

19. The method of manufacturing a multilayer ceramic capacitor according to claim 18, wherein, when the capacitor body is heated after the plating layer is formed, the capacitor body is heated at a temperature range lower than a melting point of a material of the plating layer.

20. A method of manufacturing a multilayer ceramic capacitor, the method comprising:
preparing a capacitor body that includes:
a plurality of dielectric layers;
a plurality of first inner electrode layers and a plurality of second inner electrode layers; and
a via conductor;
wherein the plurality of first inner electrode layers and the plurality of second inner electrode layers are alternately laminated in a lamination direction with the plurality of dielectric layers therebetween, and the via conductor is electrically connected to the plurality of first inner electrode layers and extends from an inside of the capacitor body to a first main surface that is a surface of the capacitor body on one side in the lamination direction;
providing a base electrode layer such that the via conductor is not exposed to an outside on the first main surface;
forming a plating layer on the base electrode layer such that at least a portion of the base electrode layer that is aligned with the via conductor in the lamination direction is exposed to the outside in the lamination direction; and
heating the capacitor body to diffuse hydrogen included in the plurality of dielectric layers in the via conductor and the base electrode layer in the lamination direction and discharge the hydrogen to the outside, after forming the plating layer.
